(19) United States
(12) Patent Application Publication
(10) Pub. No.: US 2023/0304827 A1
(43) Pub. Date: Sep. 28, 2023

(54) MAP VALIDATION METHOD AND SYSTEM

(71) Applicants: MERCEDES-BENZ GROUP, Stuttgart (DE); ROBER BOSCH GMBH, Stuttgart-Feuerbach (DE)

(72) Inventors: Manuel STUEBLER, Stuttgart (DE); Borislav ANTIC, Suttgart (DE); Manuel BIRKE, Lost Altos (DE)

(21) Appl. No.: 18/028,656

(22) PCT Filed: Jun. 16, 2021
(86) PCT No.: PCT/EP2021/066299

§ 371 Date: Mar. 27, 2023

(30) Foreign Application Priority Data
Sep. 29, 2020 (DE) 10 2020 125 448.2

(51) Int. Cl. G01C 21/00

(52) U.S. Cl. CPC G01C 21/387; G01C 21/3804

(57) ABSTRACT

Map validation method, including the steps of:
receiving (S10) sensor data of an at least semi-autonomous robot (F) for depicting at least one detected element (S3, S4, S5), wherein the at least one detected element (S3, S4, S5) represents an environmental element of the at least semi-autonomous robot (F) as detected by an environmental sensor of the at least semi-autonomous robot (F);
receiving (S20) map data (Dk) depicting a map with at least one map element (A3, A4, A5), wherein the at least one map element (A3, A4, A5) represents an environment element of the at least semi-autonomous robot (F) as plotted on a predetermined map;
receiving (S30) localization data (Dl), the localization data (Dl) indicating a position of the at least semi-autonomous robot (F) on the map;
determining (S40) a data uncertainty, wherein the data uncertainty comprises a sensor data uncertainty, a map data uncertainty, and/or a localization data uncertainty;
initializing (S50) an existence probability (P) for the at least one map element (A3, A4, A5) with an initial value;
updating (S60) the existence probability (P) of the at least one map element (A3, A4, A5) using the map data (Dk), the sensor data (Ds), the localization data (Dl), and the data uncertainties.

The present invention relates to a map validation method

### STATE OF THE ART

Currently, at least semi-autonomous robots, in particular partially automated driving vehicles, rely heavily on high-resolution maps, so-called HD maps, in particular to plan their future behavior. Relying only on sensor data from the at least semi-autonomous robot may lead to undesirable errors in the assessment of the traffic situation.

However, if the map data is outdated, future behavior of the at least semi-autonomous robot can also not be planned without error.

Therefore, there is a desire for a method to validate map data.

### DISCLOSURE OF THE INVENTION

Embodiments of the invention provide a map validation method according to the independent claims. Useful embodiments of the invention will be apparent from the dependent claims, the specification, and the accompanying figures.

According to an aspect of the invention, a map validation method, respectively a card plausibility checking method, comprises the following steps. Receiving sensor data of an at least semi-autonomous robot depicting at least one detected element, wherein the at least one detected element represents an environment element of the at least semi-autonomous robot as detected by an environmental sensor of the at least semi-autonomous robot. Receiving map data depicting a map having at least one map element, wherein the at least one map element represents an environment element of the at least semi-autonomous robot as plotted on a predetermined map. Determining localization data from the received sensor data, wherein the localization data indicates a position of the at least semi-autonomous robot on the map. Determining a data uncertainty, wherein the data uncertainty comprises a sensor data uncertainty, a map data uncertainty, and/or a localization data uncertainty. Initializing an existence probability for the at least one map element with an initial value. Updating the existence probability of the at least one map element using the map data, the sensor data, the localization data, and the data uncertainties.

Preferably, the sensor data of the at least semi-autonomous robot comprises online sensor data detected by sensors of the at least semi-autonomous robot. Preferably, the sensor data comprises camera data, lidar data, radar data, and/or GPS data.

The term “map element” as used herein particularly includes traffic signs, such as traffic signs or traffic lights, as well as road markings.

In general, the at least semi-autonomous robot can be an at least partially automated driving vehicle. Alternatively, the at least semi-autonomous robot can be another mobile robot, such as one that travels by flying, swimming, diving, or striding. For example, the mobile robot can also be an at least semi-autonomous lawn mower, or an at least semi-autonomous cleaning robot or the like.

Preferably, initializing an existence probability comprises determining an initial value for the map element existence probability, the initial value indicating a tentative existence probability assigned to the map element in the absence of sensor data.

Preferably, the localization data comprises GPS data.

Preferably, the localization data is determined using the received sensor data and the received map data. For example, the localization data is determined by matching the map data with the sensor data, in particular with the aid of GPS data. Thus, the localization data indicates an at least estimated position of the at least semi-autonomous robot on the map.

The map validation method thus uses the so-called Markov assumption, according to which the actual state depends only on the previous state and the current sensor data, but not on the complete history of states. In this way, the simplest possible computational load of the map validation method can be implemented.

Preferably, determining the data uncertainty comprises representing the sensor data, map data, and localization data in a probabilistic representation.

Preferably, the probabilistic representation comprises a Bayesian representation.

The probabilistic representation of the sensor data takes into account a spatial uncertainty of sensor measurements, an interference rate of sensor measurements, a detection probability of map elements by the sensor(s), and/or a hit- and missing hit concentrations depending on the formulation used:

A perturbation, also called a clutter, comprises a sensor measurement, i.e. sensor data that is not determined by a real object, i.e. map element, for example a ghost measurement.

A clutter rate describes the number of clutter measurements per time step, which is typically modeled using a Poisson distribution when clutter measurements occur independently.

Preferably, the map validation method is performed in the at least semi-autonomous robot, in other words online. The map validation method uses not only the map data and sensor data, but also the localization of the at least semi-autonomous robot, i.e., its estimated position with respect to the map. The task is to confirm or remove map elements and thus detect a possible discrepancy between the map data and the sensor data, i.e. the environment of the at least semi-autonomous robot.

A prerequisite for the proper functioning of the map validation method is not only a precise localization, but also an accurate sensor calibration. The reason for this is that a detected discrepancy between map data and sensor data can be caused not only by an incorrect or outdated map, but also by poor localization and an incorrectly calibrated or faulty sensor.

Preferably, a common existence probability of a map element is calculated from different sensors. Alternatively, a separate existence probability of a map element is calculated for each sensor or different sensor combinations.

Preferably, the sensor data includes data from untracked sensor measurements: Errors from sensor measurements have little or no correlation over time, unlike tracked elements, which are filtered over time. Measurements with temporally uncorrelated measurement errors are much easier to model probabilistically, and this model is also easier to check, which is done as part of the internal validity check. No measurements are lost, and the map validation method has access to all available information, including, in particular, perturbation measurements that would have been filtered out by a tracking algorithm.

Updating the existence probability falls under the concept of element fusion, or object fusion. In other words, the existence probability is calculated for map elements that are directly observable by fusing map data and sensor data. This can be performed for each sensor individually, but a joint existence probability based on all available sensor data at once or any combination of sensors is also possible.

Furthermore, an updated position of the map element is preferably calculated in addition to the existence probability. This is either done inherently by the (multi-) Bernoulli filter in the random finite set approach (RFS approach for short), or can be added as an additional Kalman filter via the logarithmic binary Bayes filter approach (logit approach for short) if required.

The calculation of the updated existence probability of map elements in the horizon is performed for visible map elements at each time step using the probabilistic representation of the input data.

In this way, improved behavior and trajectory planning with respect to safety is provided.

In this way, a holistic, accurate and actual representation of the environment of the at least semi-autonomous robot is provided based on fused sensor data and map data.

According to a preferred embodiment, the map validation method comprises the following step. Projecting the at least one map element into a sensor space of the environmental sensor.

Map elements that are part of the map horizon are projected into all relevant, e.g. forward facing, sensors, i.e. their sensor space. This projection is usually easy to accomplish, while the reverse projection from sensor coordinates to map coordinates is generally more complicated or even undefined, for example in the case of monocameras. The map horizon is a subset of the overall map, consisting of map elements in the vicinity of the at least semi-autonomous robot. This map horizon comprises at least the field of view of all relevant sensors, but is typically larger.

According to a preferred embodiment, the map validation method comprises the following step: assigning the at least one map element to the at least one detected element.

In the assigning step, a predetermined number of best global assignments of sensor data, i.e., sensor measurements, to depict elements in sensor space are computed using Murty's ranked assignment algorithm and, e.g., the Hungarian method as the underlying basis. Ranked-assignments can be based on, e.g., the multi-object measurement model from RFS-theory, which captures not only the spatial uncertainty of sensor measurements, but also the perturbation rate, perturbation intensity, and detection probability. In particular, a (multi-)Bernoulli filter is able to handle multiple associations that are weighted based on their respective probability, which is already calculated in the association step. In particular, these associations also take into account the possibility of missing sensing (map element is not assigned to any sensing) and interference sensing (sensing is not assigned to any map element).

Preferably, the associations of detected elements and map elements are synchronized only once within the system and between all modules that rely on this information. Otherwise, the map validation method would be decoupled from other functional modules that could make a completely different association and use it without checking the correctness of these potentially incorrect associations. The associations of measurements to depict map objects require the localization as input. The association relies on the predicted localization estimate from the previous time step, and the provided association is used to update the upcoming step of the localization module.

According to a preferred embodiment, the map validation method comprises the following step. Evaluating the existence probability of the at least one map element, wherein evaluating includes one of confirming the map element, disproving the map element, potentially new map element, and no possible statement.

A potentially new map element is identified if the sensor data cannot be assigned to any existing map element. In this way, potentially new map elements can be identified. In other words, a probability is determined that a measurement, i.e. the corresponding sensor data, cannot be assigned to an existing map element. Consequently, either a potentially new map element is reported or a new map element is initialized directly.

According to a preferred embodiment, updating the existence probability comprises a random finite set (RFS) approach or a logit approach.

The RFS approach refers to a sensor model based on spatial uncertainty, perturbation rate, perturbation intensity, and detection probability using random finite set theory.

The logit approach refers to a sensor model based on hit and miss rates using a log-odds implementation of a binary Bayesian filter.

The RFS approach is additionally able to provide an updated position of the map element in addition to the existence probability by applying a (multi) Bernoulli filter, where the logit approach would have to be combined with a Kalman filter to provide a position update as well.

With all of this information, it is possible to update a prior map element existence probability using either the RFS or logit approach. The existence probability specifies whether a map element still exists or not based on the collected, but uncertain, sensor data. Map elements that are not visible at all are not updated and therefore retain their existence probability from the previous time step. Updating the existence probability, and preferably the position, of a map element occurs at each time step in which a set of sensor measurements is available. Both approaches, RFS and Logit, follow the Markov assumption, where the actual state of the updated map element depends only on the current measurement and its previous state, not on the full history of the state of a map element.

Updating the existence probability is done either with a (multi-) Bernoulli filter and an RFS-based measurement model that additionally also updates the map object position with the sensor data as a by-product or a binary Bayes filter with log-likelihoods (logit) and corresponding hit/miss rates.

The multi-Bernoulli filter is based on RFS theory and takes into account the spatial uncertainty of sensor measurements, the perturbation rate/intensity of the sensor, and the detection probability of map elements.

The binary Bayes filter, also referred to simply as the logit or log-odds approach, models hits and misses of an element with specific probabilities, where measurements near a map element are considered hits and no measurements in the vicinity would be considered misses of that particular map element if it were visible.

For point-like objects—or objects that are sparsely extended relative to sensor space—the approach described can be applied directly, e.g., traffic lights, traffic signs, dashed lane markings, poles, tree trunks, points of botts, etc. Solid lane markings, e.g., boundaries, may need to be divided into smaller segments if they are too long and thus significantly exceed the sensor's field of view. Then, these smaller segments can be checked for their existence using the proposed approaches. Therefore, an existence probability is assigned to each segment of a (continuous) fixed lane boundary.

As a by-product of using the RFS approach, which relies on a (multi-) Bernoulli filter, the probability that a measurement is not part of an already existing object can be calculated. This information is a perfect indicator of a potentially new map element. Thus, additional measurements that have a high probability of not belonging to any known map element are forwarded to allow reasoning for new map elements. These measurements can also be used to create new map elements and update them in the following steps of the map validation method as well.

According to a preferred embodiment, the existence probability is initialized with an initial value of 50%.

Preferably, the initial value is predetermined. Further preferably, the initial value is determined dynamically for each map element. For example, to determine the initial value, a predetermined trend of the existence probability is determined depending on characteristics of the map element and/or map data. For example, map elements of type road sign are initialized with a lower initial probability than map elements of type traffic light, if it is assumed that road signs are usually substituted more often than traffic lights.

According to a preferred embodiment, updating the existence probability of the at least one map element is repeated at a temporal interval.

Preferably, the temporal interval is predetermined. Further, preferably, the temporal interval is dependent on a detection rate of at least one environmental sensor of the at least semi-autonomous robot. In other words, the previous existence probability of the at least one map element is updated as soon as new sensor data is available. For example, the environmental sensor of the at least semi-autonomous robot comprises a camera that provides 25 frames per second. Consequently, the prior existence probability of the at least one map element is updated 25 times per second.

According to a preferred embodiment, the map validation method comprises the following steps. Determining a visibility of a map element, wherein the visibility of the map element is determined using a field of view of the environmental sensor and an occlusion of the map element. Determining a detection probability using the visibility of the map element.

The visibility of a map element not only checks the field of view of the sensor, but also the occlusion of the respective map elements.

Preferably, the detection probability is determined using the true positive rate of the sensor.

In addition, the visibility takes into account the uncertainties of sensor measurements and map elements, as well as the uncertainties of localization and calibration information via error propagation. The visibility information can then be integrated into a detection probability. The detection probability captures not only the visibility of a map object, but generally the probability that a sensor or detection algorithm will produce a corresponding measurement. Thus, the detection probability of a non-visible object is zero, while the detection probability of a fully visible object is generally not one. The reason for this is that a sensor is typically not able to detect all visible objects, but only a certain percentage of them (cf. rate of true-positive results).

The visibility of map elements is estimated separately for each sensor, in particular by checking the perceptible field of view of the sensor and any occlusion by other objects in front of the map element, e.g. by checking the line of sight from the sensor origin to the respective map element. This can be done, for example, by using a stixel representation for a stereo camera system that provides a 3D representation of the environment. This representation can then be used to check whether such a stixel is located in front of the map element, thus obscuring it. An alternative is to use a labeled pixel image from a monocamera that can be used specifically for all map elements on the ground. The basic idea is to check if the pixels in front of the expected map element are classified as an object, e.g. a car, a pedestrian, etc., to know that it obscures a map element on the ground behind it, e.g. a lane marker.

The detection probability of a map element is then derived not only from its estimated visibility, but also from the true-positive rate of the sensor for that particular map element type. The detection probability specifies how likely it is that a map element will produce a corresponding sensor reading. This is closely related to the hit rate in the logit representation and is directly integrated into the measurement model of the RFS approach. The detection probability is zero for completely non-visible map elements and less than or equal to one for completely visible objects. The detection probability is only one for a fully visible map element and a sensor with a true-positive rate of one, i.e., the sensor does not provide any false-negative measurements in this case.

The true-positive rate specifies a percentage of detected map elements in relation to the total number of map elements present in the environment, in other words, it describes the ratio of true-positive measurements to the sum of true-positive and false-negative measurements.

The detection probability includes a probability that an existing map element will generate a corresponding measurement, i.e. sensor data. This includes the visibility of the map element and the true-positive rate of the environmental sensor.

According to a preferred embodiment, the data uncertainty is used to determine the visibility of the map element.

According to a preferred embodiment, an existence probability of the at least one map element with a detection probability below a predetermined threshold is not updated.

According to a preferred embodiment, the map validation method comprises the following step. Verifying a validity of an existence probability.

To verify the validity of the map validation method itself, the stochastic assumptions used to compute the existence probabilities are checked in the context of an internal plausibility or validity check in the at least semi-autonomous robot. This validity check reports a statistically significant deviation of assumed parameters, e.g. spatial uncertainty, perturbation rate and detection probability in the RFS-based approach or hit and miss rates in the logit approach, from the online estimated parameters at a predefined significance level. In addition, error propagation from the map to the sensor space requires linearization of a potentially nonlinear function, which is also checked for strong nonlinearities in the relevant domain as a validity check.

The stochastic and algorithmic assumptions used to update the existence probabilities are verified online as an internal validity or consistency check. Preferably, a measurement model of the environmental sensors is checked for consistency. Relevant parameters of the measurement model, e.g., spatial uncertainty of sensor measurements, sensor perturbation rate, and detection probabilities when using the RFS-based formulation, are estimated online. Subsequently, the validity check verifies that the assumptions made to calculate the existence probabilities in the first place are within a confidence interval of these online estimated parameters. For this purpose, statistical hypothesis tests are preferably performed. Preferably, the parameters are estimated online. However, they are not adjusted accordingly, again to avoid a self-fulfilling prophecy. Therefore, the estimated parameters are only checked against assumed parameters to detect a stochastic deviation between the two and to report to further modules that the plausibility check itself is no longer plausible. This is a form of self-assessment of the plausibility check itself.

According to a preferred embodiment, sensor data from different sensors of the at least semi-autonomous robot are compared to verify the validity of the existence probability.

According to a further aspect of the invention, a map validation system is configured to perform the map validation method as specified herein.

According to a further aspect of the invention, a method for controlling an at least semi-autonomous robot comprises the steps of. Performing a map validation method as specified herein for determining an existence probability of at least one map element. Determining a robot trajectory using sensor data, map data, localization data, and the existence probability of the at least one map element. Controlling the at least semi-autonomous robot based on the determined robot trajectory.

In this way, the map validation method allows behavioral and trajectory planning to safely use map data by confirming the relevant parts of the map with sensor data, in particular online sensor data of the at least semi-autonomous robot, before relying on their presence in the environment of the at least semi-autonomous robot. Based on the output of the map validation method, a behavior-planning module will know which map elements are confirmed with sensor data, which map elements are unknown, e.g., due to occlusion, and which map elements no longer exist. The map validation method thus provides a holistic view, accurate and, most importantly, actual representation of the environment of the at least semi-autonomous robot based on fused sensor and map data.

The following examples illustrate behavioral planning:

### Example 1

A vehicle approaches an intersection where a traffic light is missing, which would not be obscured if it still existed. The existence probability will slowly decrease from 50% to 0% as the vehicle approaches the missing traffic light. Behavior generation would slow the vehicle down fairly early to respond to the decreasing existence probability and eventually come to a safe stop when the traffic light is safety critical in the map to avoid entering the intersection while relying on outdated map data.

### Example 2

The vehicle is approaching an intersection where a traffic light is obscured. Behavior generation would slow the vehicle back down and/or drive around the object obscuring the traffic light if possible. The idea in this regard is to gather more information about the existence of the traffic light. If it is not possible to see the traffic light, and if it is safety critical, the vehicle would stop before the intersection.

### Example 3

The vehicle is approaching an intersection with a clearly visible traffic light. The existence probability of the traffic light will slowly increase from 50% to 100% as the vehicle approaches the intersection. Since the vehicle is now able to perceive the traffic light and also its condition, it does not need to slow down to cross the intersection safely.

According to a preferred embodiment, the method for controlling an at least semi-autonomous robot comprises the following step. Determining a control mode using the sensor data, the map data, the localization data, and the existence probability of the at least one map element, and controlling the at least semi-autonomous robot based on the determined control mode.

Preferably, the control mode comprises predefined behavioral characteristics of the at least semi-autonomous robot. For example, the control mode comprises “normal drive” mode, “preventive safety” mode, and/or “safety stop” mode. Depending on the control mode, the at least semi-autonomous robot is controlled differently given the same input data, i.e. sensor data, map data and/or localization data.

Preferably, a computer program comprises instructions that, when the computer program is executed by a computer, cause the computer program to execute a map validation method as specified herein.

Preferably, a machine-readable storage medium stores the computer program as described herein.

Advantageously, the map data comprising the at least one map element is received from a remote server and the result of the map validation method is advantageously transmitted to the remote server and used there as a basis for a decision whether an update of the at least one map element or a map resurvey at the location of the at least one map element is to be triggered. The result of the map validation method is in particular the updated existence probability of the at least one map element or information derived therefrom indicating whether the existence of the at least one map element is confirmed, disproved or whether no statement can be made about its existence.

Further measures improving the invention are described in more detail below together with the specification of preferred embodiments of the invention with reference to figures.

### EXAMPLES OF EMBODIMENTS

It shows:

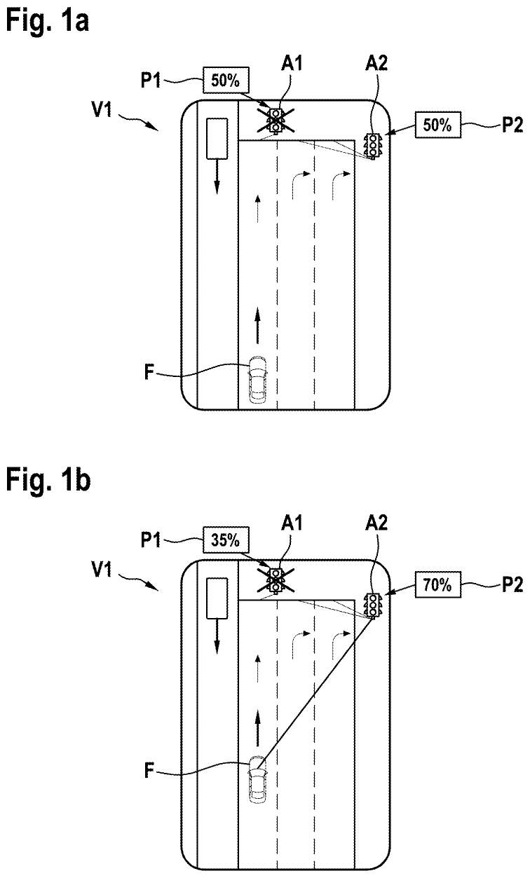

FIG. 1a a map validation method according to a first embodiment in a first time step;

FIG. 1b a map validation method according to a first embodiment in a second time step;

FIG. 1c a map validation method according to a first embodiment in a third time step;

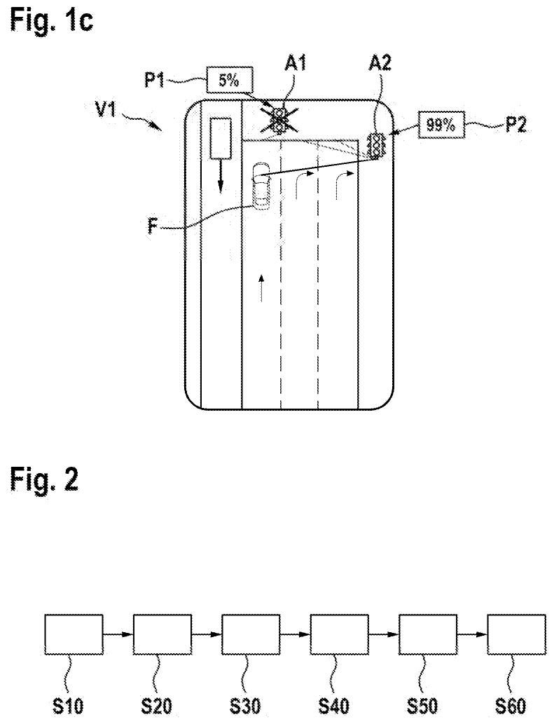

FIG. 2 a schematic representation of a map validation method;

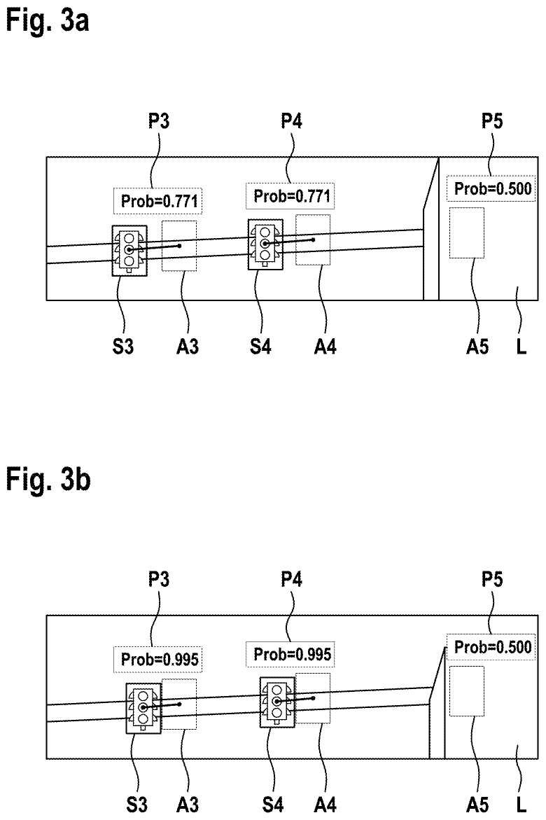

FIG. 3a a map validation method according to a second embodiment in a first time step;

FIG. 3b a map validation method according to a second embodiment in a second time step;

FIG. 3c a map validation method according to a second embodiment in a third time step; and

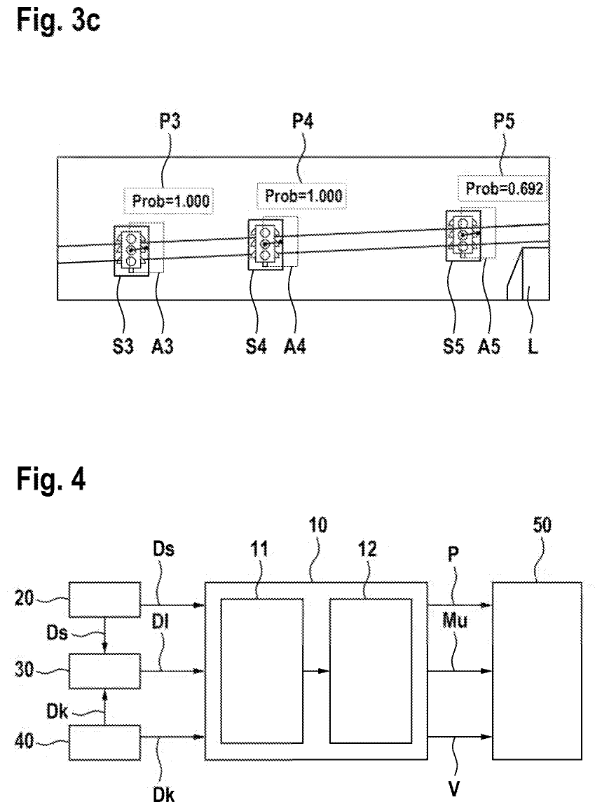

FIG. 4 a map validation system.

FIG. 1a shows a first traffic situation V1 in a first time step. An at least semi-autonomous robot, in this case an at least partially automated driving vehicle, is heading towards an intersection. From the map data of a high-precision (HD) map, two map elements, a first traffic light A1 and a second traffic light A2, can be obtained. In this case, however, the first traffic light A1 was removed due to construction work. In this respect, the map data regarding the first traffic light A1 is outdated. According to the map validation method, a first existence probability P1 and a second existence probability P2 are initialized with a value of 50% for the first traffic light A1 and the second traffic light A2. In this first time step, the vehicle F is still comparatively far away from the intersection. The sensor data provided by environmental sensors of the vehicle F do not have a detected element to the first traffic light A1 nor to the second traffic light A2. In the first time step, a plausibility check is performed in which the first existence probability P1 and the second existence probability P2 are updated. In the plausibility check, based on internal statistics and localization data of the vehicle F, it is determined that the vehicle F is still far enough away from the intersection that the environmental sensors of the vehicle F cannot detect either the first traffic light A1 or the second traffic light A2. In other words, the first traffic light A1 and the second traffic light A2 are not in the field of view of the environmental sensors of the vehicle F. Thus, it is determined that no further statement can be made about the first existence probability P1 and the second existence probability P2 based on the sensor data. In this respect, the first existence probability P1 remains at 50% and the second existence probability P2 remains at 50%. For the control of the at least partially automated driving vehicle, based on the sufficient distance of the vehicle F to the intersection, it is decided to continue driving at normal speed. A control mode of the vehicle in this case is “normal driving”.

FIG. 1b shows the first traffic situation V1 in a second time step. The at least partially automated vehicle F is closer to the intersection than in the first time step. In the second time step, a plausibility check is performed in which the first existence probability P1 and the second existence probability P2 are updated. In the plausibility check, based on internal statistics and the localization data of the vehicle F, it is determined that the vehicle F is already close enough to the intersection that the environmental sensors of the vehicle F should be able to detect both the first traffic light A1 and the second traffic light A2. In other words, the first traffic light A1 and the second traffic light A2 are within the visual range of the environmental sensors of the vehicle F. Thus, it is determined that based on the sensor data, a statement can be made about the first existence probability P1 and the second existence probability P2. Since the first traffic light A1, as specified, no longer exists, the environmental sensors of the vehicle F also do not detect any element at the expected location from the map data. In contrast, the second traffic light A2 is still at the expected location from the map data In this respect, the first existence probability P1 is reduced from 50% to 35% and the second existence probability P2 is increased from 50% to 70%. For the control of the at least partially automated driving vehicle, based on the first existence probability P1 and the second existence probability P2, it is decided to slightly decelerate the vehicle F, so that there is more time to measure the environment in order to be able to make further statements, in particular about the first traffic light A1. The control mode of the vehicle F changes from “normal driving” to “preventive safety”.

In this case, a difference in the first traffic light A1 between the sensor data and the map data was detected in the plausibility check. If the first traffic light A1 had also been detected by the environmental sensors of the vehicle F, a first existence probability P1 would have been increased from 50% to 70% and the control mode of the vehicle F would have remained unchanged at “normal driving”.

FIG. 1c shows the first traffic situation V1 in a third time step. The at least partially automated vehicle F is closer to the intersection than in the second time step. In the third time step, a plausibility check is performed in which the first existence probability P1 and the second existence probability P2 are updated. In the plausibility check, based on internal statistics and the localization data of the vehicle F, it is determined that the vehicle F is still close enough to the intersection that the environmental sensors of the vehicle F should be able to detect both the first traffic light A1 and the second traffic light A2. In other words, the first traffic light A1 and the second traffic light A2 are within the visual range of the environmental sensors of the vehicle F. Thus, it is determined that based on the sensor data, a statement can be made about the first existence probability P1 and the second existence probability P2. Since the first traffic light A1, as specified, no longer exists, the environmental sensors of the vehicle F continue to detect no element at the expected location from the map data. In contrast, the second traffic light A2 is still at the expected location from the map data In this respect, the first existence probability P1 is reduced from 35% to 5% and the second existence probability P2 is increased from 70% to 99%. Based on the first existence probability P1 and the second existence probability P2, a decision is made for the control of the at least partially automated vehicle to bring the vehicle F to a safe stop before the intersection, since there is a high probability that a possible critical situation has arisen due to the absence of the first traffic light A1. The control mode of the vehicle F changes here from “preventive safety” to “safety stop”. In this situation, a tele-operation of the vehicle F is requested from a monitoring center, by which the traffic situation for the vehicle F is to be solved manually. Furthermore, an update of the map data or an updated measurement of the intersection is initiated.

FIG. 2 shows a map validation method comprising the following steps. In a first step 310, sensor data of a vehicle is received depicting at least one detected element, the at least one detected element representing an environment element of the vehicle as detected by an environmental sensor of the vehicle. In a second step S20, map data is received depicting a map having at least one map element, the at least one map element representing an environment element of the vehicle as plotted on a predetermined map. In a third step S30, localization data is determined from the received sensor data, the localization data indicating a position of the vehicle on the map. In a fourth step S40, a data uncertainty is determined, the data uncertainty comprising a sensor data uncertainty, a map data uncertainty, and/or a localization data uncertainty. In a fifth step 350, an existence probability for the at least one map element is initialized. In a sixth step S60, the existence probability of the at least one map element is updated using the map data, sensor data, localization data, and data uncertainties.

FIG. 3a shows a second traffic situation V2 in a first time step.

The at least partially automated driving vehicle F is located near an intersection. From the map data of a high precision (HD) map, three map elements, a third traffic light A3, a fourth traffic light A4 and a fifth traffic light A5, can be seen. In this case, the third traffic light A3, the fourth traffic light A4 and the fifth traffic light A5 are actually still present. In this respect, the map data are actual.

However, only a third detected element S3, which can be assigned to the third traffic light A3, and a fourth detected element S4, which can be assigned to the fourth traffic light A4, result from the sensor data.

According to the map validation method, a third existence probability P3, a fourth existence probability P4 and a fifth existence probability P5 are initialized with a value of 50% for the third traffic light A3, the fourth traffic light A4 and the fifth traffic light A5.

In the first time step, a plausibility check is performed in which the third existence probability P3, the fourth existence probability P4 and the fifth existence probability P5 are updated. In the plausibility check, based on internal statistics and localization data of the vehicle F, it is determined that the vehicle F is close enough to the intersection that the environmental sensors of the vehicle F should be able to detect the third traffic light A3, the fourth traffic light A4, and the fifth traffic light A5. However, the sensor data from the vehicle F also reveals that there is a truck L, LKW, in the vicinity of the vehicle F that is in the line of sight between the environmental sensors of the vehicle F and the fifth traffic light A5. In other words, the third traffic light A3 and the fourth traffic light A4 are in the field of view of the environmental sensors of the vehicle F and the fifth traffic light A5 is not in the field of view of the environmental sensors of the vehicle F. Thus, it is determined that no further statement can be made about the fifth existence probability P5, but it can be made about the third existence probability P3 and the fourth existence probability P4. In this respect, in the first time step the fifth existence probability P5 remains at 50% and the third existence probability P3 and the fourth existence probability P4 are increased from 50% to 77.1%.

FIG. 3b shows the second traffic situation V2 in a second time step.

From the sensor data, there is furthermore only a third detected element S3, which can be assigned to the third traffic light A3, and a fourth detected element S4, which can be assigned to the fourth traffic light A4.

In the second time step, a plausibility check is performed in which the third existence probability P3, the fourth existence probability P4, and the fifth existence probability P5 are updated. In the plausibility check, based on internal statistics and localization data of the vehicle F, it is determined that the vehicle F is still close enough to the intersection that the environmental sensors of the vehicle F should be able to detect the third traffic light A3, the fourth traffic light A4, and the fifth traffic light A5. However, the sensor data of the vehicle F continues to reveal that there is a truck L, LKW, in the vicinity of the vehicle F that is in the field of view between the environmental sensors of the vehicle F and the fifth traffic light A5. In other words, furthermore, the third traffic light A3 and the fourth traffic light A4 are in the field of view of the environmental sensors of the vehicle F and the fifth traffic light A5 is not in the field of view of the environmental sensors of the vehicle F. Thus, it is determined that no further statement can be made about the fifth existence probability P5, but it can be made about the third existence probability P3 and the fourth existence probability P4. In this respect, in the second time step, the fifth existence probability P5 remains at 50% and the third existence probability P3 and the fourth existence probability P4 are each increased from 77.1% to 99.5%.

FIG. 3c shows the second traffic situation V2 in a third time step.

The sensor data now results in a third detected element S3, which can be assigned to the third traffic light A3, a fourth detected element S4, which can be assigned to the fourth traffic light A4, and a fifth detected element S5, which can be assigned to the fifth traffic light A5.

In the third time step, a plausibility check is performed in which the third existence probability P3, the fourth existence probability P4, and the fifth existence probability P5 are updated. In the plausibility check, based on internal statistics and localization data of the vehicle F, it is determined that the vehicle F is still close enough to the intersection that the environmental sensors of the vehicle F should be able to detect the third traffic light A3, the fourth traffic light A4, and the fifth traffic light A5. In addition, the sensor data of the vehicle F also reveals that the truck L, which is in the vicinity of the vehicle F, is no longer in the field of view between the environmental sensors of the vehicle F and the fifth traffic light A5. In other words, the third traffic light A3, the fourth traffic light A4 and the fifth traffic light are in the visual range of the environmental sensors of the vehicle F. Thus, it is determined that a statement can be made about the fifth existence probability P5, the third existence probability P3 and the fourth existence probability P4. In this respect, in the third time step, the fifth existence probability P5 increases from 50% to 69.5% and the third existence probability P3 and the fourth existence probability P4 are increased from 99.5% to 100%.

FIG. 4 shows a map validation system 10 comprising an object-mapping unit 11 and an object fusion unit 12. The map validation system 10 is coupled as input to a sensor system 20, a localization system 30, and a map system 40. Further, the map validation system 10 is coupled as output to a behavior planning system 50.

The sensor system 20 provides sensor data Ds. The map system 40 provides map data Dk. The localization system 30 determines localization data DI from the sensor data Ds and the map data Dk. The sensor data Ds, the map data Dk and the localization data DI are provided to the map validation system 10, in particular to the object allocation unit 11.

The object-mapping unit 11 is specific to the sensor type and is instantiated once for each sensor. The object-mapping unit 11 is configured to project map elements onto the respective sensor space, e.g., into the camera coordinate system, and is configured to estimate the visibility of the map elements in the sensor space, e.g., based on stixels potentially blocking the line of sight to these map elements. The object assignment unit 11 is further configured to calculate the k best associations using a probabilistic formulation of the sensor data and a ranked assignment algorithm, e.g., using Murty's algorithm. The object assignment is outsourced from the actual map plausibility check, since it is not specific to the map and its result could be used by other modules, e.g. localization. The object-mapping unit 11 is thus configured to project the map elements into the sensor space, or in other words into the sensor coordinate system, to determine, in particular estimate, the visibility of the map elements, and to assign the sensor data, i.e. sensor measurements, to depict map elements in the sensor space.

The object fusion unit 12 is configured to update the existence probability of the map element and optionally also to update the position of the map element. Furthermore, the object fusion unit 12 is configured to identify the sensor data, i.e. sensor measurements that are not assigned to any existing map element and thus potentially identify new map elements. The object fusion unit 12 is configured to check a correctness of algorithmic/stochastic assumptions, i.e. to check a validity of the existence probability.

Consequently, the map validation system 10 provides map elements with existence probabilities P, unassigned measurements Mu and validity check results V to the behavior planning system 50. Consequently, the behavior planning system 50 controls a behavior of the at least partially automated driving vehicle based on the provided data.

1. A map validation method, comprising:
receiving sensor data of an at least semi-autonomous robot for depicting at least one detected element, wherein the at least one detected element represents an environmental element of the at least semi-autonomous robot as detected by an environmental sensor of the at least semi-autonomous robot;
receiving map data depicting a map with at least one map element, wherein the at least one map element represents an environment element of the at least semi-autonomous robot as plotted on a predetermined map;
receiving localization data, the localization data indicating a position of the at least semi-autonomous robot on the map;
determining a data uncertainty, wherein the data uncertainty comprises a sensor data uncertainty, a map data uncertainty, and/or a localization data uncertainty;
initializing an existence probability for the at least one map element with an initial value; and
updating the existence probability of the at least one map element using the map data, the sensor data, the localization data, and the data uncertainties.

2. The map validation method according to of claim 1, further comprising:
projecting the at least one map element into a sensor space of the environmental sensor.

3. The map validation method according to any one of the preceding claim 1, further comprising:
assigning the at least one map element to the at least one detected element.

4. The map validation method according to claim 1, further comprising:
evaluating the existence probability of the at least one map element, wherein the evaluating comprises one of confirming the map element, disproving the map element, potentially new map element, or no possible statement.

5. The map validation method according to claim 1, wherein the updating the existence probability comprises a random finite set approach or a logit approach.

6. The map validation method according to claim 1, wherein the existence probability is initialized with an initial value of 50%.

7. The map validation method according to claim 1, wherein updating the existence probability of the at least one map element is repeated in a temporal interval.

8. The map validation method according to claim 1, further comprising:
determining a visibility of the at least one map element, wherein the visibility of the at least one map element is determined using a field of view of the ambient sensor and an occlusion of the map element; and
determining a detection probability using the visibility of the at least one map element.

9. The map validation method according to claim 1, wherein the data uncertainty is used to determine the visibility of the at least one map element.

10. The map validation method according to claim 1, wherein the existence probability of the at least one map element having a detection probability below a predetermined threshold is not updated.

11. The map validation method according to claim 1, further comprising verifying a validity of the existence probability.

12. The map validation method according to claim 11, further comprising comparing the sensor data from different sensors of the at least semi-autonomous robot are compared to each other for verifying the validity of the existence probability.

13. A map validation system comprising:
at least one computer processing system which is configured to perform procedures comprising:
receiving sensor data of an at least semi-autonomous robot for depicting at least one detected element, wherein the at least one detected element represents an environmental element of the at least semi-autonomous robot as detected by an environmental sensor of the at least semi-autonomous robot;
receiving map data depicting a map with at least one map element, wherein the at least one map element represents an environment element of the at least semi-autonomous robot as plotted on a predetermined map;
receiving localization data, the localization data indicating a position of the at least semi-autonomous robot on the map;
determining a data uncertainty, wherein the data uncertainty comprises a sensor data uncertainty, a map data uncertainty, and/or a localization data uncertainty;
initializing an existence probability for the at least one map element with an initial value; and
updating the existence probability of the at least one map element using the map data, the sensor data, the localization data, and the data uncertainties.

14. A method for controlling at least semi-autonomous robot, comprising:
performing a map validation procedure for determining an existence probability of at least one map element, wherein the map validation procedure comprises
receiving sensor data of an at least semi-autonomous robot for depicting at least one detected element, wherein the at least one detected element represents an environmental element of the at least semi-autonomous robot as detected by an environmental sensor of the at least semi-autonomous robot;
receiving map data depicting a map with at least one map element, wherein the at least one map element represents an environment element of the at least semi-autonomous robot as plotted on a predetermined map;
receiving localization data, the localization data indicating a position of the at least semi-autonomous robot on the map;
determining a data uncertainty, wherein the data uncertainty comprises a sensor data uncertainty, a map data uncertainty, and/or a localization data uncertainty;
initializing an existence probability for the at least one map element with an initial value; and
updating the existence probability of the at least one map element using the map data, the sensor data, the localization data, and the data uncertainties;
determining a robot trajectory using the sensor data, the map data, the localization data, and the existence probability of the at least one map element; and
controlling the at least semi-autonomous robot based on the determined robot trajectory.

15. The method according to claim 14, further comprising:
determining a control mode using the sensor data, the map data, the localization data, and the existence probability of the at least one map element; and
controlling the at least semi-autonomous robot based on the determined control mode.
